(19) United States
(12) Patent Application Publication
(10) Pub. No.: US 2022/0307827 A1
(43) Pub. Date: Sep. 29, 2022

(54) SCANNING EQUIPMENT

(71) Applicant: TG3D Studio, Taipei City (TW)

(72) Inventors: Hsien CHOU, Taipei City (TW); Yu-Lin TSAI, Taipei City (TW)

(21) Appl. No.: 17/656,424

(22) Filed: Mar. 25, 2022

(30) Foreign Application Priority Data
Mar. 25, 2021 (TW) 110110950

(51) Int. Cl. G01B 21/20; F16M 11/38

(52) U.S. Cl. CPC G01B 21/20; F16M 11/38

(57) ABSTRACT

A scanning equipment includes a control module, a frame, a rod, two first scanning devices and a second scanning device. The frame connects the control module and has two opposite first ends. The frame is bendable such that the first ends are movable towards or away from each other. A second end of the rod connects one of the first ends. The first scanning devices are disposed at the first ends. The second scanning device is disposed at a third end of the rod. When the scanning equipment is in usage, the frame forms a long structure and the control module locates between the first scanning devices along a first direction. When the scanning equipment is in storage, the frame bends and the control module locates between the first scanning devices and the second scanning device along a second direction perpendicular to the first direction.

### RELATED APPLICATIONS

This application claims priority to Taiwanese Application Serial Number 110110950 filed Mar. 25, 2022, which is herein incorporated by reference.

### BACKGROUND

### Technical Field

The present disclosure relates to scanning equipment.

### Description of Related Art

With the improvement of living standard of people, three-dimensional scanning technique to human body is developed. A scanning equipment for human body can carry out three-dimensional scanning to the dimensions of a human body. Thus, a user can accurately understand the condition of his body shape. Apart from the tailored clothing and virtual fitting, the application of this technique can also be extended to medical service, fitness, game and virtual reality.

In order to increase the accuracy of scanning of human body, scanning equipment focusing on a particular part of a human body has gradually become popular. For example, scanning equipment for foot focuses on the measurement of the foot of a body, such that accurate data of measurement for a foot can be provided.

### SUMMARY

A technical aspect of the present disclosure is to provide a scanning equipment, which can largely reduce the space to be occupied for the sake of storage.

According to an embodiment of the present disclosure, a scanning equipment includes a control module, a bendable frame, at least one first connecting rod, two first scanning devices and at least one second scanning device. The bendable frame is connected with the control module. The bendable frame has two opposite first ends. The bendable frame is bendable such that the first ends are movable towards or away from each other. The first connecting rod has a second end and a third end opposite to the second end. The second end is pivotally connected with one of the first ends. The first scanning devices are rotatably disposed at the first ends. The first scanning devices are electrically connected with the control module respectively. The second scanning device is rotatably disposed at the third end. The second scanning device is electrically connected with the control module. The scanning equipment is switchable between a status of usage and a status of storage. When the scanning equipment is in the status of usage, the bendable frame forms a long structure and the control module is at least partially located between the first scanning devices along a first direction. When the scanning equipment is in the status of storage, the bendable frame bends and the control module is at least partially located between the first scanning devices and the second scanning device along a second direction. The first direction and the second direction are substantially perpendicular to each other.

In one or more embodiments of the present disclosure, the bendable frame includes a central portion and two second connecting rods. The control module is pivotally connected with the central portion. An end of each of the second connecting rods is pivotally connected with the central portion. The first ends are respectively located at another end of the corresponding second connecting rod away from the central portion.

In one or more embodiments of the present disclosure, each of the second connecting rods has a length. The lengths are equal to each other.

In one or more embodiments of the present disclosure, the first connecting rod is retractable.

In one or more embodiments of the present disclosure, each of the first scanning devices includes a first turntable, a first supporting frame and a first scanner. The first turntable is rotatably connected with the corresponding first end. The first supporting frame is pivotally connected with the first turntable. The first scanner is pivotally connected with the first supporting frame.

In one or more embodiments of the present disclosure, when the scanning equipment is in the status of storage, each of the first scanners rotates relative to the corresponding first supporting frame and is at least partially accommodated inside the corresponding first supporting frame, while each of the first supporting frames rotates relative to the corresponding first turntable and is substantially parallel with the first connecting rod.

In one or more embodiments of the present disclosure, the second scanning device includes a second turntable, a second supporting frame and a second scanner. The second turntable is rotatably connected with the third end. The second supporting frame is pivotally connected with the second turntable. The second scanner is pivotally connected with the second supporting frame.

In one or more embodiments of the present disclosure, when the scanning equipment is in the status of storage, the second scanner rotates relative to the second supporting frame and is at least partially accommodated inside the second supporting frame, while the second supporting frame rotates relative to the second turntable and is substantially parallel with the first connecting rod.

In one or more embodiments of the present disclosure, the scanning equipment is in the status of usage, the first connecting rod and the bendable frame define a scanning zone. The first scanning devices and the second scanning device at least partially face to the scanning zone.

In one or more embodiments of the present disclosure, a quantity of the first connecting rod and a quantity of the second scanning device are respectively two. The first connecting rods are substantially parallel with each other.

According to an embodiment of the present disclosure, a scanning equipment includes a bendable frame, a control module, two first connecting rods, two first scanning devices and two second scanning devices. The bendable frame has two opposite first ends. The bendable frame is bendable such that the first ends are movable towards or away from each other. The control module is connected with the bendable frame mid-way between the first ends. The first connecting rods are substantially parallel with each other. Each of the first connecting rods has a second end and a third end opposite to the second end. Each of the second ends is pivotally connected with the corresponding first end. The first scanning devices are rotatably disposed at the first ends and electrically connected with the control module respectively. The second scanning devices are rotatably disposed at the third ends and electrically connected with the control module respectively. The first connecting rods can remain parallel with each other substantially after the bendable frame is completely bent.

In one or more embodiments of the present disclosure, the bendable frame includes a central portion and two second connecting rods. The control module is pivotally connected with the central portion. An end of each of the second connecting rods is pivotally connected with the central portion. The first ends are respectively located at another end of the corresponding second connecting rod away from the central portion.

In one or more embodiments of the present disclosure, each of the second connecting rods has a length. The lengths are equal to each other.

In one or more embodiments of the present disclosure, each of the first connecting rods is retractable.

In one or more embodiments of the present disclosure, each of the first scanning devices includes a first turntable, a first supporting frame and a first scanner. The first turntable is rotatably connected with the corresponding first end. The first supporting frame is pivotally connected with the first turntable. The first scanner is pivotally connected with the first supporting frame.

In one or more embodiments of the present disclosure, each of the first scanners is configured to rotate relative to the corresponding first supporting frame and be at least partially accommodated inside the corresponding first supporting frame. Each of the first supporting frames is configured to rotate relative to the corresponding first turntable and be substantially parallel with the corresponding first connecting rod.

In one or more embodiments of the present disclosure, each of the second scanning devices includes a second turntable, a second supporting frame and a second scanner. The second turntable is rotatably connected with the corresponding third end. The second supporting frame is pivotally connected with the second turntable. The second scanner is pivotally connected with the second supporting frame.

In one or more embodiments of the present disclosure, each of the second scanners is configured to rotate relative to the corresponding second supporting frame and is at least partially accommodated inside the corresponding second supporting frame. Each of the second supporting frames is configured to rotate relative to the corresponding second turntable and is substantially parallel with the corresponding first connecting rod.

In one or more embodiments of the present disclosure, the first connecting rods and the bendable frame define a scanning zone. The first scanning devices and the second scanning devices at least partially face to the scanning zone when the first connecting rods are away from each other.

The above-mentioned embodiments of the present disclosure have at least the following advantages:

(1) When the scanning equipment is in the status of storage, the first connecting rods are still substantially parallel with each other, while the bendable frame bends and the second connecting rods are also substantially parallel with each other. The control module is at least partially located between the first scanning devices and the second scanning devices. In this way, the space to be occupied by the scanning equipment is largely reduced in an effective manner, which facilitates the storage by a user. In addition, for example, the user can accommodate the scanning equipment in the status of storage into a tote bag or a suitcase, such that the scanning equipment can be carried around conveniently.

(2) When the scanning equipment is in the status of storage, since the control module is at least partially located between the first scanning devices and the second scanning devices, i.e., the control module is at least partially located between the first supporting frames and the second supporting frames, the control module is under a structural protection. Thus, the chance that the control module to be damaged due to a direct impact is effectively reduced.

(3) Since the first connecting rods can extend according to the actual situation in order to carry out scanning to large items, the flexibility of application of the scanning equipment can be effectively increased.

### BRIEF DESCRIPTION OF THE DRAWINGS

The disclosure can be more fully understood by reading the following detailed description of the embodiments, with reference made to the accompanying drawings as follows:

FIG. 1 is a schematic view of a scanning equipment according to an embodiment of the present disclosure, in which the scanning equipment is in the status of usage;

FIG. 2 is a schematic view of the scanning equipment of FIG. 1, in which the first scanning devices and the second scanning devices are already rotated and respectively align with the corresponding first connecting rod, while the bendable frame is being bent and the first connecting rods are rotating relative to the bendable frame;

FIG. 3 is a schematic view of the scanning equipment of FIG. 2, in which the bending of the bendable frame is complete;

FIG. 4 is a schematic view of the scanning equipment of FIG. 3, in which the first scanners and the second scanners are respectively rotating relative to the corresponding first supporting frame and the corresponding second supporting frame;

FIG. 5 is a schematic view of the scanning equipment of FIG. 4, in which the rotations of the first scanners and the second scanners respectively relative to the corresponding first supporting frame and the corresponding second supporting frame are complete, and the first scanners and the second scanners are at least partially accommodated inside the corresponding first supporting frame and the corresponding second supporting frame respectively;

FIG. 6 is a schematic view of the scanning equipment of FIG. 5, in which the scanning equipment is in the status of storage;

FIG. 7 is a schematic view of a scanning equipment according to an embodiment of the present disclosure, in which the first connecting rods are in the status of extension; and

FIG. 8 is a schematic view of a scanning equipment according to another embodiment of the present disclosure, in which the scanning equipment is in the status of usage.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

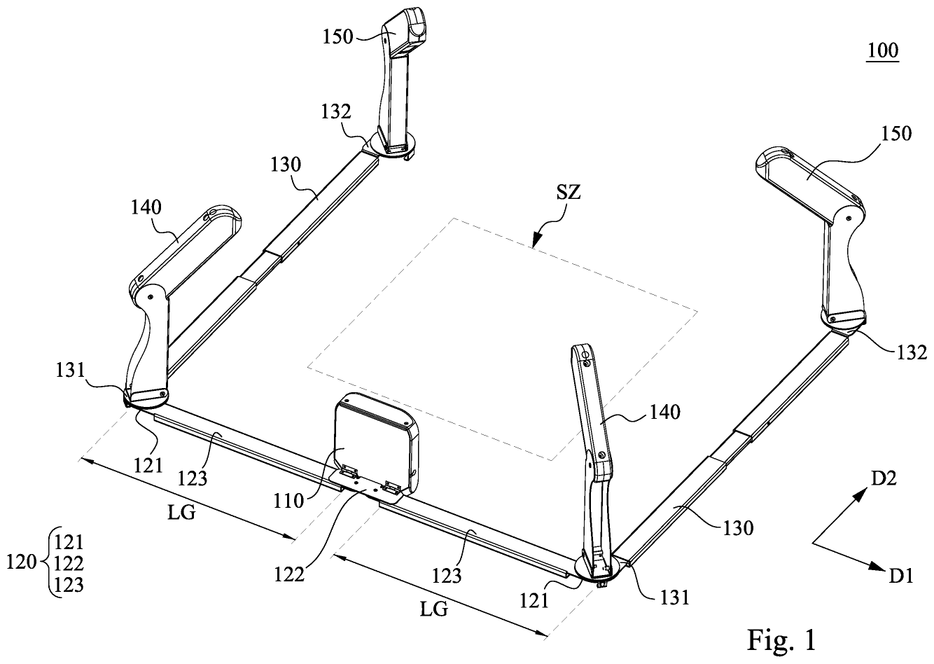

Reference is made to FIG. 1. FIG. 1 is a schematic view of a scanning equipment 100 according to an embodiment of the present disclosure, in which the scanning equipment 100 is in the status of usage. As shown in FIG. 1, the scanning equipment 100 is in the status of usage. In this embodiment, the scanning equipment 100 includes a control module 110, a bendable frame 120, two first connecting rods 130, two first scanning devices 140 and two second scanning devices 150. The bendable frame 120 has two first ends 121 opposite to each other. In practice, the control module 110 is connected with the bendable frame 120 mid-way between the first ends 121. The first connecting rods 130 respectively have a second end 131 and a third end 132 opposite to the second end 131. The second ends 131 are respectively and pivotally connected with the corresponding first end 121 of the bendable frame 120. The first scanning devices 140 are rotatably disposed at the first ends 121 of the bendable frame 120. The first scanning devices 140 are electrically connected with the control module 110 respectively. The second scanning devices 150 are rotatably disposed at the third ends 132. The second scanning devices 150 are electrically connected with the control module 110 respectively. The electrical connections in this disclosure can be accomplished by wireless connection or connection via wire(s). For example, when the electrical connection is a wireless connection, the wireless connection can be accomplished by using Bluetooth transmission device, infra-red transmission device or WIFI wireless network transmission device etc. When the electrical connection is a connection via wire(s), the connection via wire(s) can be accomplished by physical cable(s), and the type of the physical cable(s) is not restricted.

When the scanning equipment 100 is in the status of usage, as shown in FIG. 1, the bendable frame 120 forms a long structure and the control module 110 is at least partially located between the first scanning devices 140 along a first direction D1, while the bendable frame 120 and the two first connecting rods 130 abut against a ground (not shown). It is worth to note that, the first connecting rods 130 substantially extend along a second direction D2 and are parallel with each other, while the first connecting rods 130 and the bendable frame 120 define a scanning zone SZ. The second direction D2 is substantially perpendicular to the first direction D1. For example, the scanning zone SZ allows a user to step thereon. Moreover, when the first connecting rods 130 are away from each other, the first scanning devices 140 and the second scanning devices 150 at least partially face to the scanning zone SZ, and are respectively configured to carry out scanning of the feet or the shoes of the user under the control of the control module 110. The data obtained by scanning is transmitted to the control module 110 through the electrical connection mentioned above. However, it is noted that, the scanning of the feet or the shoes of the user as cited above is only illustrative, and the scanning equipment 100 is not restricted to only scan the feet or the shoes of the user. Any item which can be completely placed on the scanning zone SZ can also be scanned.

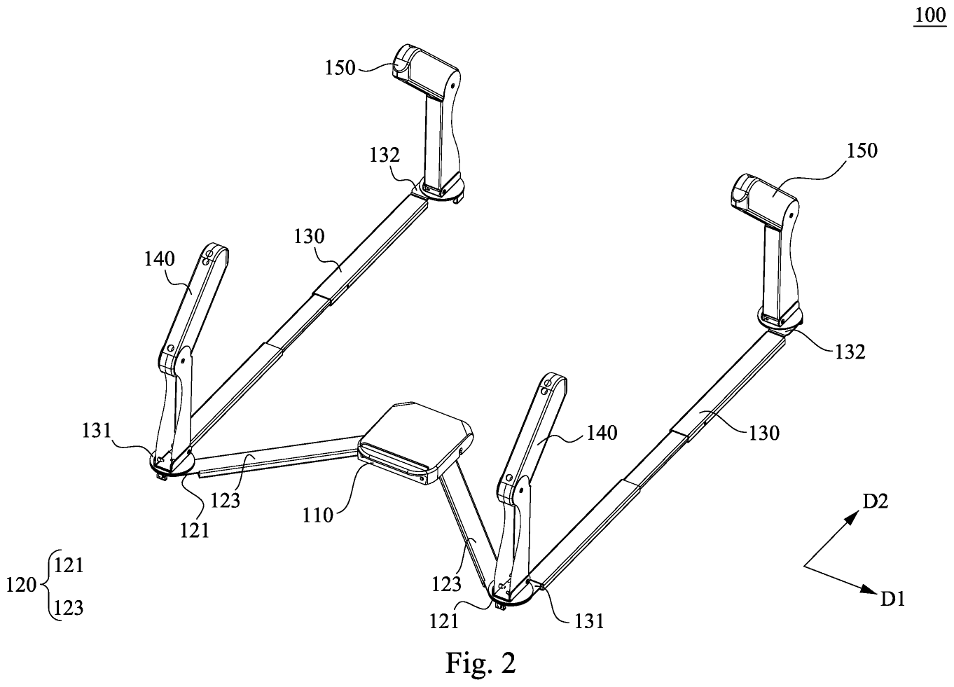

Reference is made to FIG. 2. FIG. 2 is a schematic view of the scanning equipment 100 of FIG. 1, in which the first scanning devices 140 and the second scanning devices 150 are already rotated and respectively align with the corresponding first connecting rod 130, while the bendable frame 120 is being bent and the first connecting rods 130 are rotating relative to the bendable frame 120. As shown in FIG. 2, the scanning equipment 100 is being switched from the status of usage to the status of storage. In addition, in this embodiment, the bendable frame 120 is bendable such that the first ends 121 of the bendable frame 120 are movable towards or away from each other. In this way, the scanning equipment 100 can be switched between the status of usage and the status of storage.

Furthermore, in order to facilitate the subsequent storage, the first scanning devices 140 and the second scanning devices 150 respectively rotate relative to the corresponding first connecting rod 130, such that the respective extension directions of the first scanning devices 140 and the second scanning devices 150 at least partially align with the extension direction of the first connecting rods 130. In addition, as shown in FIG. 2, the first ends 121 of the bendable frame 120 can move gradually towards each other through the bending of the bendable frame 120.

To be specific, as shown in FIGS. 1-2, the bendable frame 120 includes a central portion 122 (the central portion 122 is blocked by the control module 110 and thus not shown in FIG. 2) and two second connecting rods 123. An end of each of the second connecting rods 123 is pivotally connected with the central portion 122, and the central portion 122 is at least partially and pivotally connected between the second connecting rods 123. The first ends 121 are respectively located at another end of the corresponding second connecting rod 123 away from the central portion 122. Moreover, the control module 110 is pivotally connected with the central portion 122 of the bendable frame 120. This means the control module 110 is rotatable relative to the central portion 122. For example, the control module 110 can rotate by 90 degrees relative to the central portion 122. In this embodiment, as shown in FIG. 1, when the scanning equipment 100 is in the status of usage, the control module 110 is vertical to the bendable frame 120 for the sake of operation by a user. As shown in FIG. 2, when the scanning equipment 100 is switched to the status of storage, the control module 110 is horizontal to the bendable frame 120 for the sake of storage.

In this embodiment, as shown in FIG. 1, each of the second connecting rods 123 has a length LG. The lengths LG of the two second connecting rods 123 are equal to each other, facilitating the usage and storage of the scanning equipment 100.

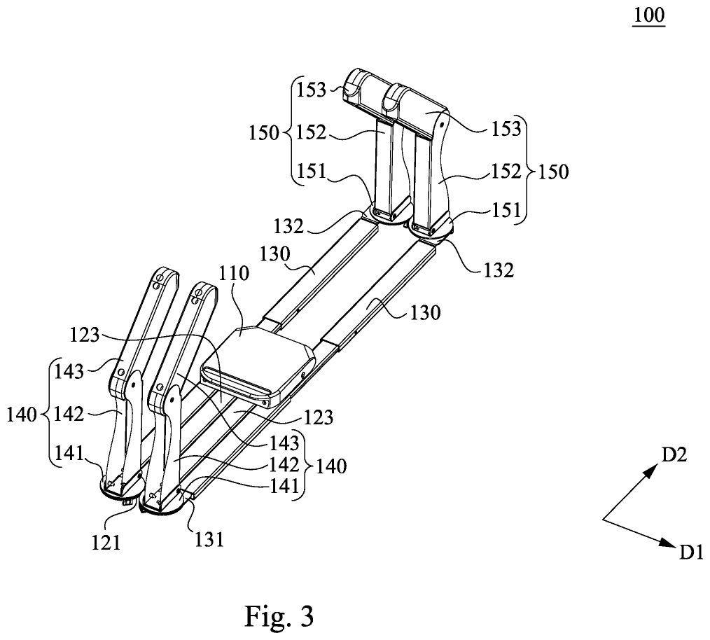

Reference is made to FIG. 3. FIG. 3 is a schematic view of the scanning equipment 100 of FIG. 2, in which the bending of the bendable frame 120 is complete. It is worth to note that, the rotations of the first connecting rods 130 relative to the bendable frame 120 and the rotations of the second connecting rods 123 relative to the central portion 122 are both carried out in the plane defined by the first direction D1 and the second direction D2. In other words, the rotations of the first connecting rods 130 relative to the bendable frame 120 and the rotations of the second connecting rods 123 relative to the central portion 122 can be carried out in a horizontal plane parallel with the ground. In addition, the first connecting rods 130 can remain parallel with each other substantially after the bendable frame 120 is completely bent.

Furthermore, to be specific, in this embodiment, as shown in FIG. 3, each of the first scanning devices 140 includes a first turntable 141, a first supporting frame 142 and a first scanner 143. The first turntable 141 is rotatably connected with the corresponding first end 121. The first supporting frame 142 is pivotally connected with the first turntable 141. The first scanner 143 is pivotally connected with the first supporting frame 142. In other words, the first supporting frame 142 is pivotally connected between the first turntable 141 and the first scanner 143. Since each of the first turntables 141 is rotatably connected with the corresponding first end 121 of the bendable frame 120, each of the first scanning devices 140 can rotate relative to the bendable frame 120 and the corresponding first connecting rod 130.

Similarly, in this embodiment, as shown in FIG. 3, each of the second scanning devices 150 includes a second turntable 151, a second supporting frame 152 and a second scanner 153. The second turntable 151 is rotatably connected with the third end 132 of the corresponding first connecting rod 130. The second supporting frame 152 is pivotally connected with the second turntable 151. The second scanner 153 is pivotally connected with the second supporting frame 152. In other words, the second supporting frame 152 is pivotally connected between the second turntable 151 and the second scanner 153. Since each of the second turntables 151 is rotatably connected with the third end 132 of the corresponding first connecting rod 130, each of the second scanning devices 150 can rotate relative to the corresponding first connecting rod 130.

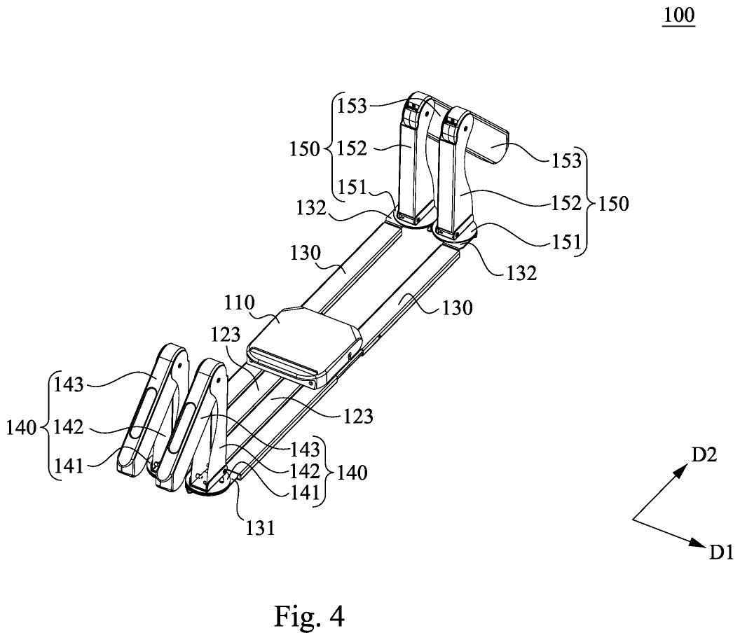

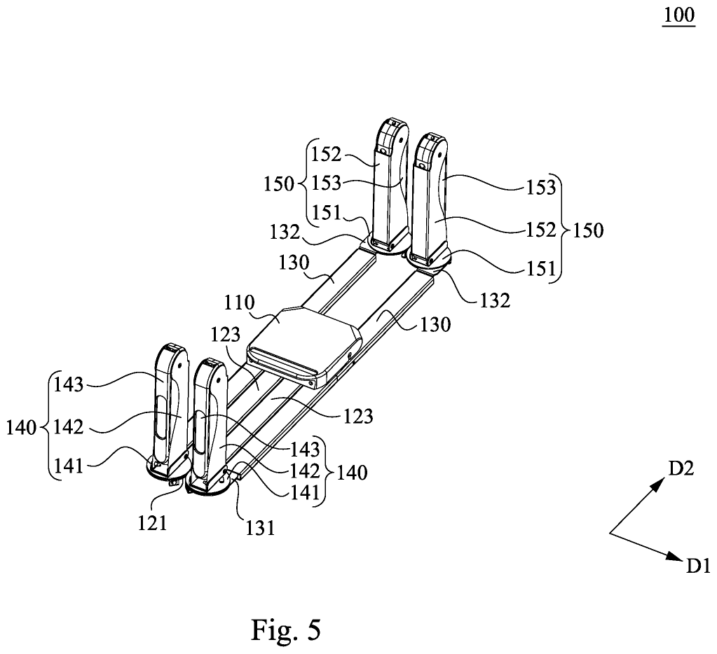

Reference is made to FIGS. 4-5. FIG. 4 is a schematic view of the scanning equipment 100 of FIG. 3, in which the first scanners 143 and the second scanners 153 are respectively rotating relative to the corresponding first supporting frame 142 and the corresponding second supporting frame 152. FIG. 5 is a schematic view of the scanning equipment 100 of FIG. 4, in which the rotations of the first scanners 143 and the second scanners 153 respectively relative to the corresponding first supporting frame 142 and the corresponding second supporting frame 152 are complete, and the first scanners 143 and the second scanners 153 are at least partially accommodated inside the corresponding first supporting frame 142 and the corresponding second supporting frame 152 respectively.

As shown in FIGS. 4-5, when the scanning equipment 100 is switched to the status of storage, the first scanners 143 are respectively rotated relative to the corresponding first supporting frame 142 and are at least partially accommodated inside the corresponding first supporting frame 142, while the first supporting frames 142 together with the corresponding first scanner 143 rotate relative to the corresponding first turntable 141 and move close to the corresponding first connecting rod 130, until each of the first supporting frames 142 is substantially parallel with the corresponding first connecting rod 130.

On the other hand, the second scanners 153 are also respectively rotated relative to the corresponding second supporting frame 152 and are at least partially accommodated inside the corresponding second supporting frame 152, while the second supporting frames 152 together with the corresponding second scanner 153 rotate relative to the corresponding second turntable 151 and move close to the corresponding first connecting rod 130, until each of the second supporting frames 152 is substantially parallel with the corresponding first connecting rod 130.

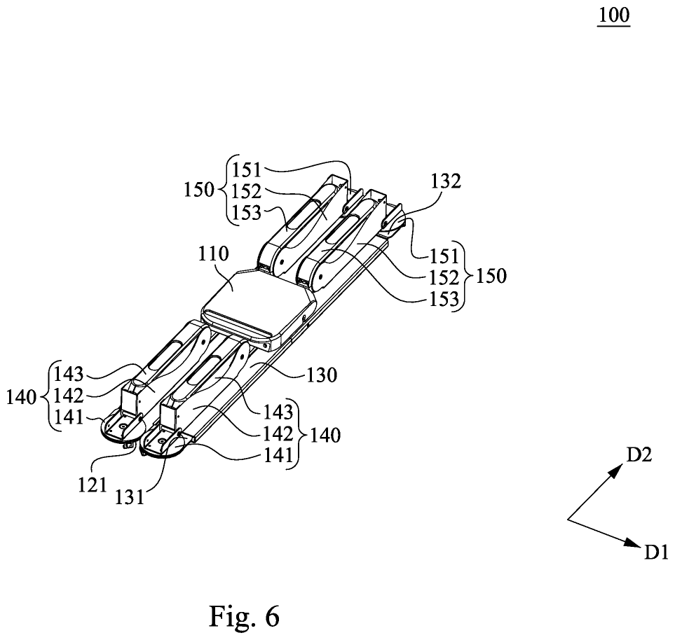

Reference is made to FIG. 6. FIG. 6 is a schematic view of the scanning equipment 100 of FIG. 5, in which the scanning equipment 100 is in the status of storage. In this embodiment, as shown in FIG. 6, when the scanning equipment 100 is in the status of storage, the first connecting rods 130 are still substantially parallel with each other, while the bendable frame 120 bends and the second connecting rods 123 are also substantially parallel with each other. The control module 110 is at least partially located between the first scanning devices 140 and the second scanning devices 150 along the second direction D2. In this way, the space to be occupied by the scanning equipment 100 is largely reduced in an effective manner, which facilitates the storage by a user. In addition, for example, the user can accommodate the scanning equipment 100 in the status of storage into a tote bag or a suitcase, such that the scanning equipment 100 can be carried around conveniently.

In addition, when the scanning equipment 100 is in the status of storage, since the control module 110 is at least partially located between the first scanning devices 140 and the second scanning devices 150, i.e., the control module 110 is at least partially located between the first supporting frames 142 and the second supporting frames 152, the control module 110 is under a structural protection. Thus, the chance that the control module 110 to be damaged due to a direct impact is effectively reduced.

In practical applications, when the scanning equipment 100 is in the status of usage or the status of storage, appropriate methods of fixing can be applied to the pivotal connection between the control module 110 and the central portion 122, the pivotal connection between the central portion 122 and the second connecting rods 123, the pivotal connection between the first connecting rods 130 and the second connecting rods 123, the rotatable connection between each of the first turntables 141 and the corresponding first connecting rod 130, the pivotal connection between each of the first supporting frames 142 and the corresponding first turntable 141, the pivotal connection between each of the first scanners 143 and the corresponding first supporting frame 142, the rotatable connection between each of the second turntables 151 and the corresponding first connecting rod 130, the pivotal connection between each of the second supporting frames 152 and the corresponding second turntable 151, the pivotal connection between each of the second scanners 153 and the corresponding second supporting frame 152. For example, the methods of fixing include but not limited to locking of screws, fixing of bolts, pressing by tolerances, snapping pieces of different types, etc.

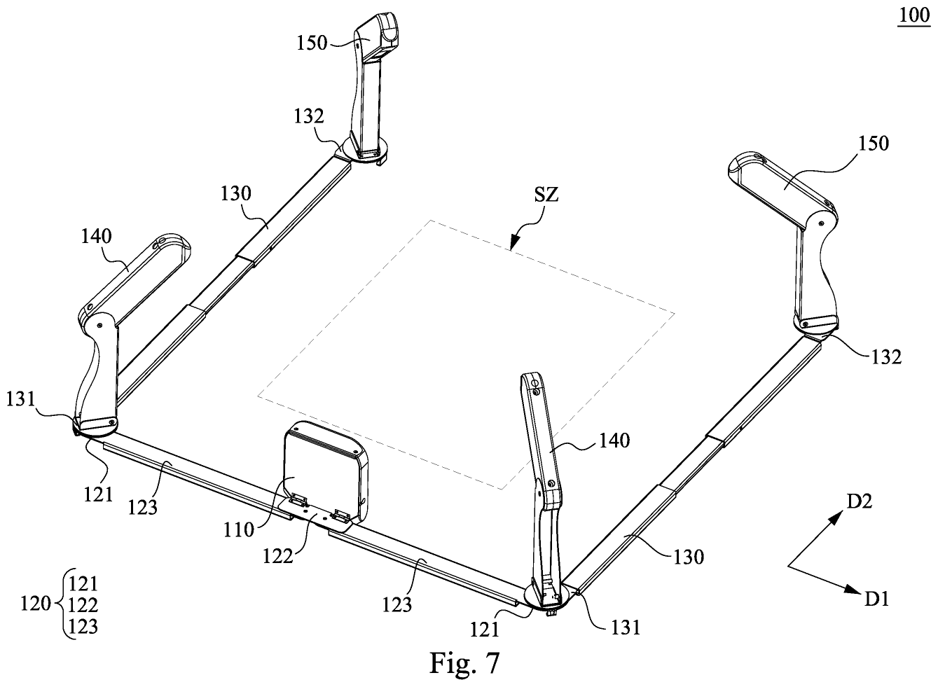

Reference is made to FIG. 7. FIG. 7 is a schematic view of a scanning equipment 100 according to an embodiment of the present disclosure, in which the first connecting rods 130 are in the status of extension. In this embodiment, the first connecting rods 130 are respectively retractable. As shown in FIG. 7, the first connecting rods 130 can extend according to the actual situation, in order to carry out scanning to large items. In this way, the flexibility of application of the scanning equipment 100 can be effectively increased.

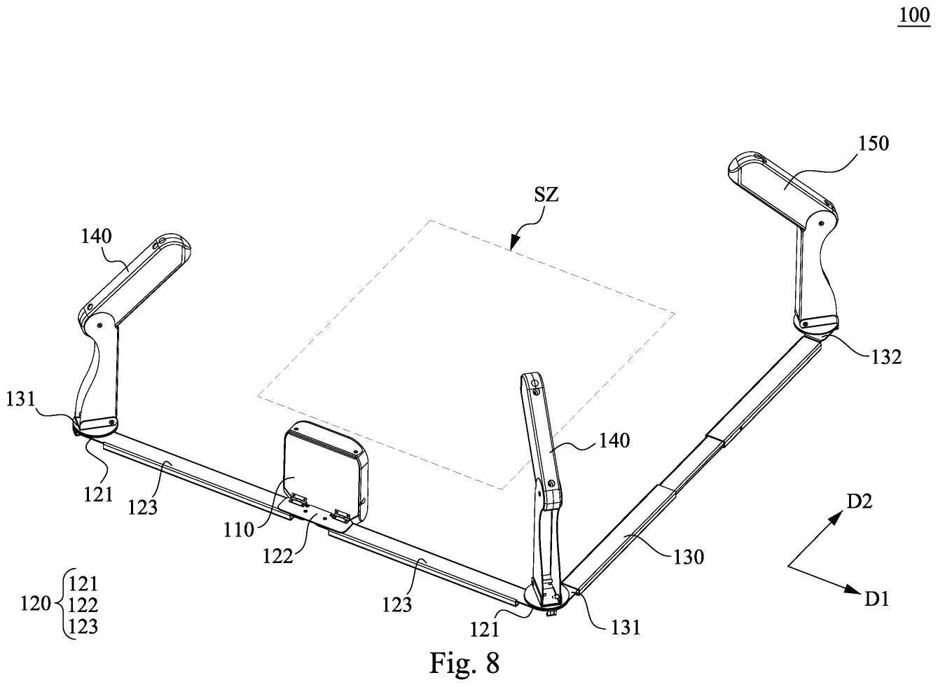

Reference is made to FIG. 8. FIG. 8 is a schematic view of a scanning equipment 100 according to another embodiment of the present disclosure, in which the scanning equipment 100 is in the status of usage. In this embodiment, as shown in FIG. 8, according to the actual situation, a user can arrange the quantity of the first connecting rod 130 and the second scanning device 150 to be one set. Then, two numbers of the first scanning devices 140 and one number of the second scanning device 150 carry out scanning to the item placed on the scanning zone SZ.

In conclusion, the aforementioned embodiments of the present disclosure have at least the following advantages:

(1) When the scanning equipment is in the status of storage, the first connecting rods are still substantially parallel with each other, while the bendable frame bends and the second connecting rods are also substantially parallel with each other. The control module is at least partially located between the first scanning devices and the second scanning devices. In this way, the space to be occupied by the scanning equipment is largely reduced in an effective manner, which facilitates the storage by a user. In addition, for example, the user can accommodate the scanning equipment in the status of storage into a tote bag or a suitcase, such that the scanning equipment can be carried around conveniently.

(2) When the scanning equipment is in the status of storage, since the control module is at least partially located between the first scanning devices and the second scanning devices, i.e., the control module is at least partially located between the first supporting frames and the second supporting frames, the control module is under a structural protection. Thus, the chance that the control module to be damaged due to a direct impact is effectively reduced.

(3) Since the first connecting rods can extend according to the actual situation in order to carry out scanning to large items, the flexibility of application of the scanning equipment can be effectively increased.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A scanning equipment, comprising:
a control module;
a bendable frame connected with the control module and having two opposite first ends, the bendable frame being bendable such that the first ends are movable towards or away from each other;
at least one first connecting rod having a second end and a third end opposite to the second end, the second end pivotally connecting with one of the first ends;
two first scanning devices rotatably disposed at the first ends and electrically connected with the control module respectively; and
at least one second scanning device rotatably disposed at the third end and electrically connected with the control module,
wherein the scanning equipment is switchable between a status of usage and a status of storage, when the scanning equipment is in the status of usage, the bendable frame forms a long structure and the control module is at least partially located between the first scanning devices along a first direction, when the scanning equipment is in the status of storage, the bendable frame bends and the control module is at least partially located between the first scanning devices and the second scanning device along a second direction, the first direction and the second direction are substantially perpendicular to each other.

2. The scanning equipment of claim 1, wherein the bendable frame comprises:
a central portion, the control module is pivotally connected with the central portion; and
two second connecting rods, an end of each of the second connecting rods is pivotally connected with the central portion, the first ends are respectively located at another end of the corresponding second connecting rod away from the central portion.

3. The scanning equipment of claim 2, wherein each of the second connecting rods has a length, the lengths are equal to each other.

4. The scanning equipment of claim 1, wherein the first connecting rod is retractable.

5. The scanning equipment of claim 1, wherein each of the first scanning devices comprises:
a first turntable rotatably connected with the corresponding first end;
a first supporting frame pivotally connected with the first turntable; and
a first scanner pivotally connected with the first supporting frame.

6. The scanning equipment of claim 5, wherein when the scanning equipment is in the status of storage, each of the first scanners rotates relative to the corresponding first supporting frame and is at least partially accommodated inside the corresponding first supporting frame, each of the first supporting frames rotates relative to the corresponding first turntable and is substantially parallel with the first connecting rod.

7. The scanning equipment of claim 1, wherein the second scanning device comprises:
a second turntable rotatably connected with the third end;
a second supporting frame pivotally connected with the second turntable; and
a second scanner pivotally connected with the second supporting frame.

8. The scanning equipment of claim 7, wherein when the scanning equipment is in the status of storage, the second scanner rotates relative to the second supporting frame and is at least partially accommodated inside the second supporting frame, the second supporting frame rotates relative to the second turntable and is substantially parallel with the first connecting rod.

9. The scanning equipment of claim 1, wherein when the scanning equipment is in the status of usage, the first connecting rod and the bendable frame define a scanning zone, the first scanning devices and the second scanning device at least partially face to the scanning zone.

10. The scanning equipment of claim 1, wherein a quantity of the first connecting rod and a quantity of the second scanning device are respectively two, the first connecting rods are substantially parallel with each other.

11. A scanning equipment, comprising:
a bendable frame having two opposite first ends, the bendable frame being bendable such that the first ends are movable towards or away from each other;
a control module connected with the bendable frame mid-way between the first ends;
two first connecting rods being substantially parallel with each other, each of the first connecting rods having a second end and a third end opposite to the second end, each of the second ends pivotally connecting with the corresponding first end;
two first scanning devices rotatably disposed at the first ends and electrically connected with the control module respectively; and
two second scanning devices rotatably disposed at the third ends and electrically connected with the control module respectively,
wherein the first connecting rods can remain parallel with each other substantially after the bendable frame is completely bent.

12. The scanning equipment of claim 11, wherein the bendable frame comprises:
a central portion, the control module is pivotally connected with the central portion; and
two second connecting rods, an end of each of the second connecting rods is pivotally connected with the central portion, the first ends are respectively located at another end of the corresponding second connecting rod away from the central portion.

13. The scanning equipment of claim 12, wherein each of the second connecting rods has a length, the lengths are equal to each other.

14. The scanning equipment of claim 11, wherein each of the first connecting rods is retractable.

15. The scanning equipment of claim 11, wherein each of the first scanning devices comprises:
a first turntable rotatably connected with the corresponding first end;
a first supporting frame pivotally connected with the first turntable; and
a first scanner pivotally connected with the first supporting frame.

16. The scanning equipment of claim 15, wherein each of the first scanners is configured to rotate relative to the corresponding first supporting frame and be at least partially accommodated inside the corresponding first supporting frame, while each of the first supporting frames is configured to rotate relative to the corresponding first turntable and be substantially parallel with the corresponding first connecting rod.

17. The scanning equipment of claim 11, wherein each of the second scanning devices comprises:
a second turntable rotatably connected with the corresponding third end;
a second supporting frame pivotally connected with the second turntable; and
a second scanner pivotally connected with the second supporting frame.

18. The scanning equipment of claim 17, wherein each of the second scanners is configured to rotate relative to the corresponding second supporting frame and is at least partially accommodated inside the corresponding second supporting frame, while each of the second supporting frames is configured to rotate relative to the corresponding second turntable and is substantially parallel with the corresponding first connecting rod.

19. The scanning equipment of claim 11, wherein the first connecting rods and the bendable frame define a scanning zone, the first scanning devices and the second scanning devices at least partially face to the scanning zone when the first connecting rods are away from each other.
